(19) United States
(12) Patent Application Publication
(10) Pub. No.: US 2017/0357777 A1
(43) Pub. Date: Dec. 14, 2017

(54) HYBRID SYSTEM FOR COLLECTING AND UTILIZING PATIENT GENERATED INFORMATION

(71) Applicant: Mark D. Oswald, San Diego, CA (US)

(72) Inventor: Mark D. Oswald, San Diego, CA (US)

(21) Appl. No.: 15/617,100

(22) Filed: Jun. 8, 2017

Related U.S. Application Data
(60) Provisional application No. 62/392,727, filed on Jun. 8, 2016.

(51) Int. Cl. G06F 19/00

(52) U.S. Cl. CPC G06F 19/363; G06F 19/322

(57) ABSTRACT

A hybrid of traditional paper-based (analog) data collection forms and content, in combination with a set of digital software services is provided. This system embodies method and software components collect patient information such as health profile data, health measurements, and health assessments. This information is collected from the patient using a uniquely designed paper format and then translated into digital information. This digital information is then used to personalize a health management program with relevant content and iteratively presented back to the patient, again in paper form.

### CROSS-REFERENCE TO RELATED APPLICATION

This application claims the benefit of priority of U.S. provisional application No. 62/392,727, filed 8 Jun. 2016, the contents of which are herein incorporated by reference.

### BACKGROUND OF THE INVENTION

The present invention relates to a system for collecting patient-generated health data as part of a personalized health management program and, more particularly, to a hybrid of traditional paper-based (analog) data collection forms and content, in combination with a set of digital software services.

Current approaches to collecting patient-generated health data live exclusively in the digital domain or the analog/paper world. Over the years, the majority of patient health programs have existed with only paper-based content and forms. More recently, numerous web sites and mobile applications for presenting health content and collecting health information digitally have developed.

As a result, today's patient engagement programs aren't scalable or effective. Mobile and digital health solutions are too complex, too costly, and provide the wrong user experience for most of the target population, i.e., the patients that need them the most. On the other hand, 100-percent paper-based solutions don't provide a feedback loop and don't allow for collection of personal health data or personalized content delivery.

As can be seen, there is a need for a hybrid of traditional paper-based (analog) data collection forms and content, in combination with a set of digital software services, providing the right user experience (physical/paper) with all the benefits of a digital information system through combining a digital back-end with a front-end delivery channel based on physical media. The program of the present invention supports patient-generated data collection (assessments, health measurements, etc.) and personalized content delivery with structured health programs and branded content by incorporating a data collection mechanism which results in digital information. This digital information, in turn, is used within a feedback loop which uses the same physical/paper communication channel to deliver personalized and programmed health content.

### SUMMARY OF THE INVENTION

In one aspect of the present invention, method and software components collect patient information such as health profile data, health measurements, and health assessments. This information is collected from the patient using a uniquely designed paper format and then translated into digital information. This digital information is then used to personalize a health management program with relevant content and iteratively presented back to the patient, again in paper form.

In another aspect of the present invention, a method of providing a personalize a health management program includes providing an initial booklet in a paper format to establish a baseline health profile for a predetermined health management program, wherein the paper format provides a separable survey having a plurality of questions related to health information pertinent to the predetermined health management program; prompting a user to hand-write answer to the plurality of questions, wherein the hand-written answers comprise health data; prompting the user to mail said initial survey to a predetermined address; providing a computing system to receive and translate the hand-written answers into a digital patient profile comprising the health data, wherein the computing system is configured to associate the predetermined health management program with the digital patient profile for generating at least one personalized booklet based in part thereon; and providing the at least one personalized booklet in said paper format to the user.

In yet another aspect of the present invention, a hybrid of traditional paper-based (analog) data collection forms and content, in combination with a set of digital software services embodies the above-mentioned method and further includes at least one personalized booklet having personalized health content based in part on the digital patient profile, wherein each separable survey includes a tear-off mailer mechanism, wherein the tear-off mailer mechanism further comprises a tear line connecting the respective booklet and separable survey, wherein each separable survey further comprises at least one fold line, peel-away paper and adhesive for mailing in the separable survey, wherein the personalized health content includes goals associated with the predetermined health management program, and wherein the computing system further includes a data capture service for translating the hand-written answers into the digital patient profile; a personalization service coupled to the data capture for composing the personalized health content based on the digital patient profile; and a print service coupled to the personalization service for generating at least one personalized booklet.

These and other features, aspects and advantages of the present invention will become better understood with reference to the following drawings, description and claims.

### BRIEF DESCRIPTION OF THE DRAWINGS

FIG. 1 is a process flowchart of an exemplary embodiment of the present invention;

FIG. 2 is a continuation of FIG. 1;

FIG. 3 is a perspective view of an exemplary embodiment of a booklet of the present invention used in collecting and presenting patient health information;

FIG. 4 is a perspective view of an exemplary embodiment of a mail-in survey illustrating a fold;

FIG. 5 is a perspective view of an exemplary embodiment of an educational or profile booklet;

FIG. 6 is a flowchart of an exemplary embodiment of the present invention;

FIG. 7 is a data diagram of an exemplary embodiment of a patient's profile of the present invention; and

FIG. 8 is a data diagram of an exemplary embodiment of a program model the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a hybrid of traditional paper-based (analog) data collection forms and content, in combination with a set of digital software services. This system embodies method and software components collect patient information such as health profile data, health measurements, and health assessments. This information is collected from the patient using a uniquely designed paper format and then translated into digital information. This digital information is then used to personalize a health management program with relevant content and iteratively presented back to the patient, again in paper form.

The present invention may include at least one computer with a user interface. The computer may include at least one processing unit and a form of memory including, but not limited to, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

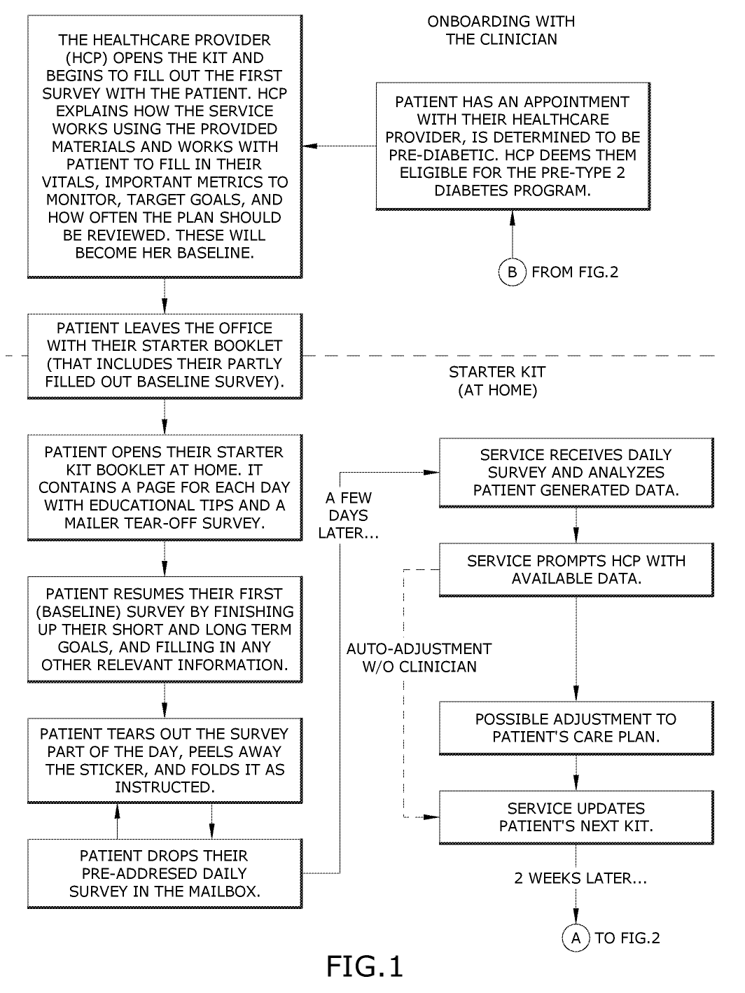

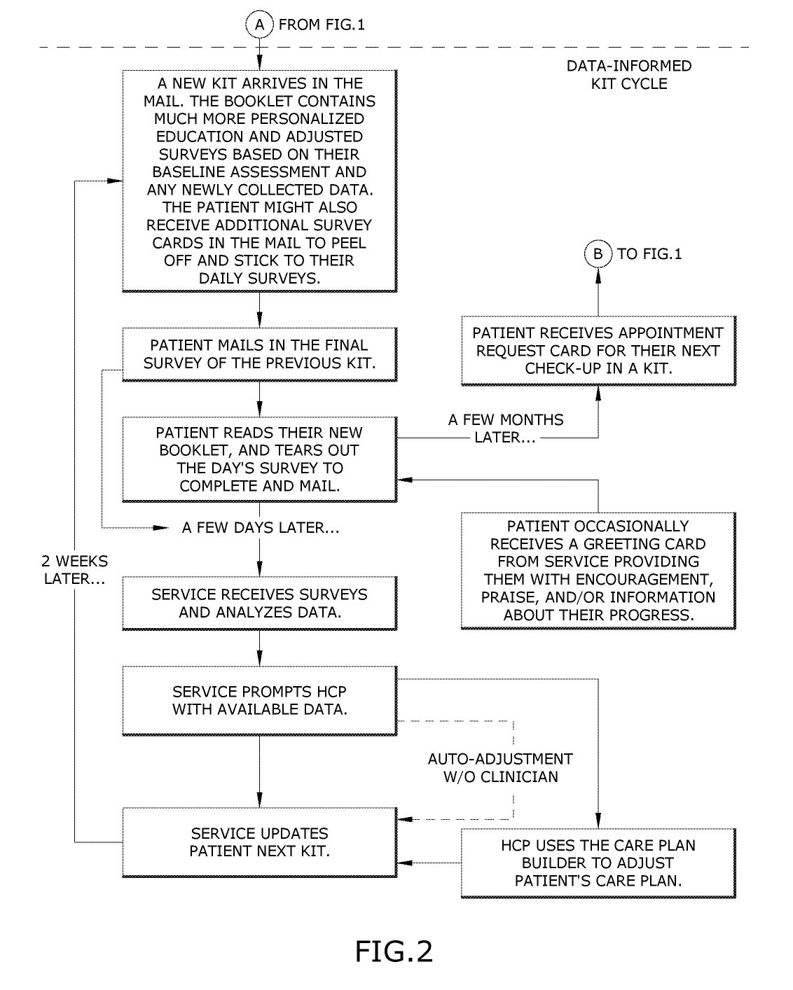

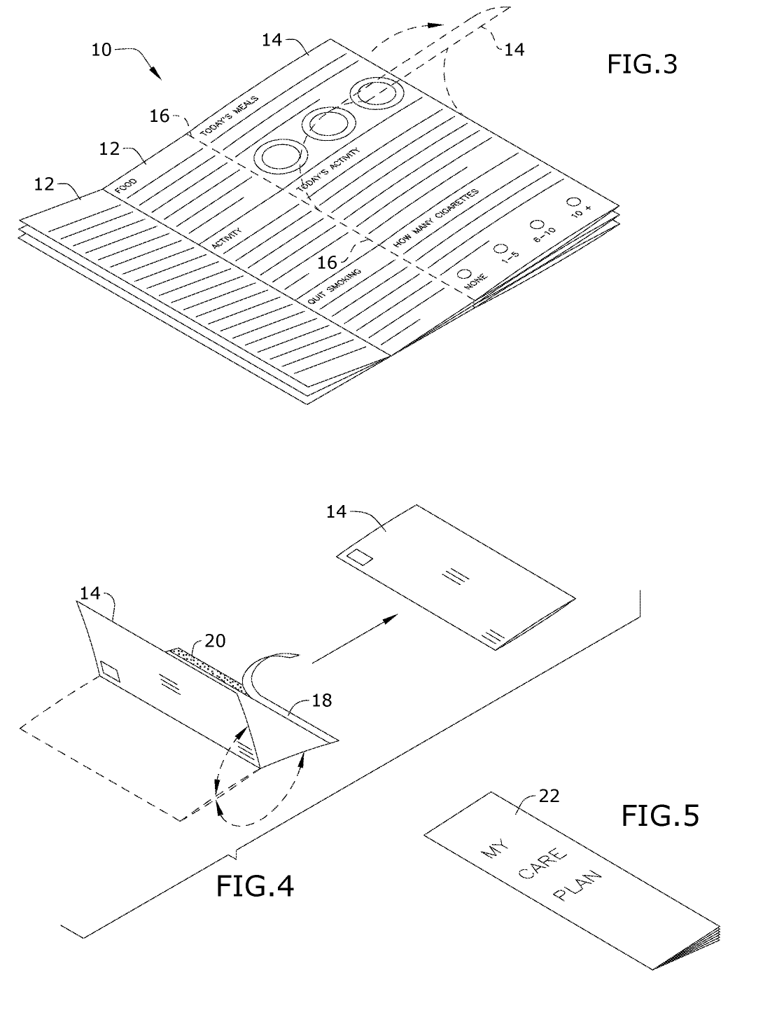

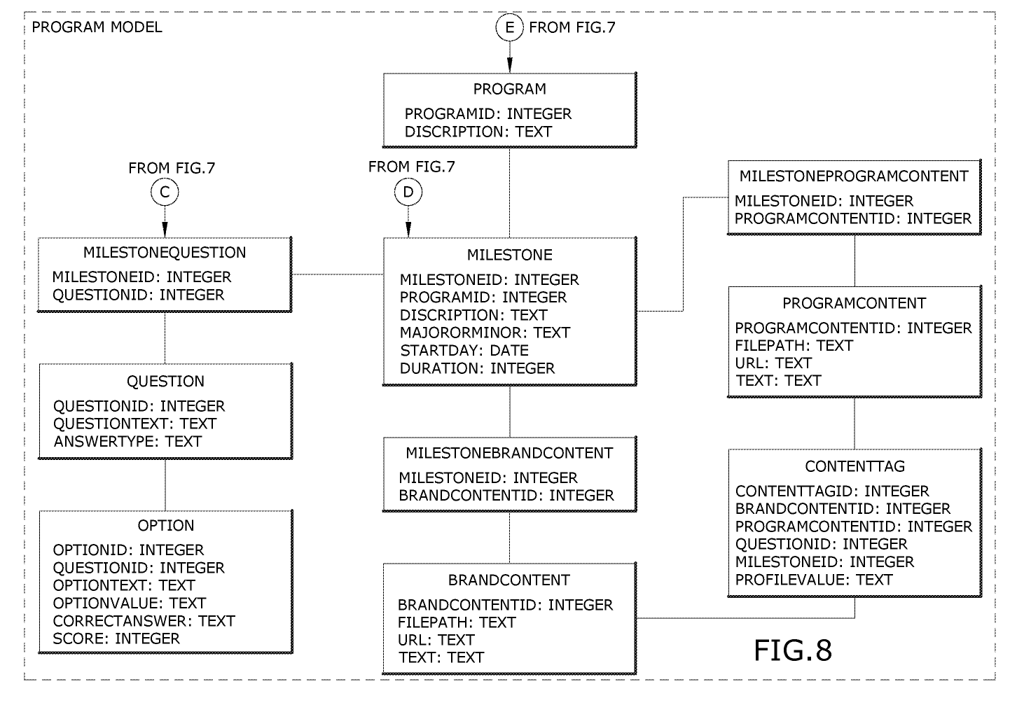

Referring to FIGS. 1 through 8, the present invention may embody a method of providing a personalized health management program. The user 24 experience may begin with receiving the initial content kit/booklet 10, which is not personalized for each individual patient-user 24, but general in nature relating to a health topic such as pre-diabetes or heart health. The user 24 may register for the program by completing the initial survey to establish their baseline health profile and account. The initial survey may be initiated or finalized during an initial appointment for a healthcare provider or can be initiated and/or finalized in a take home paper format, such as the content kit/booklet 10, wherein a mail-in survey 14 with tear lines 16 may be torn from the content kit/booklet 10 and mailed in via a unique booklet and mailer design having peel-away paper 18 and adhesive 20, as illustrated in FIG. 4. Receipt of this initial survey establishes the user 24-patient in the system embodying the method of the present invention. The system may associate a unique identity/identifier that is encoded into the booklet(s). On subsequent days, the user 24 reads the relevant health content 12 and completes additional surveys, collecting various health measurements, activities, assessments, etc. These surveys may also be torn from the booklet and mailed in a similar fashion as mentioned above.

Once the initial phase of the program is complete, and all surveys have been completed, the user 24 will receive an additional booklet 22, which has both program content and additional data collection surveys. Unlike the first kit, the content of this program booklet 22 is highly personalized based on the digital patient profile that is being created behind the scenes.

The program booklets 22 are a unique design that combines relevant health content with data collection forms. Pages of the booklet that have data collection forms also have a tear-off section, which can be folded and mailed. The hand-written form data is converted into digital information using automated recognition and translation techniques. There is also a patient identity encoded on each mailer so that all data can be associated with the correct patient profile.

In an additional embodiment, the program content and survey forms may be incorporated into a traditional notebook system, such as a three-ring (or other) binder. This alternative form factor would still be used to organize the relevant program content, including both static content as well as more dynamic and personalized content and information.

In another embodiment, the program content and survey forms may be part of a delivery mechanism which combines stored video content on a low-cost embedded LCD screen (as one example) along with printed content and survey forms.

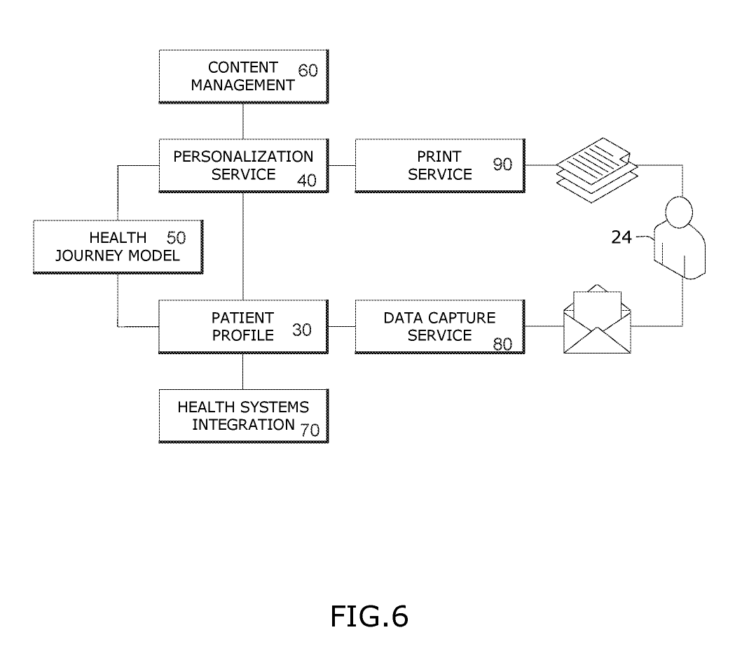

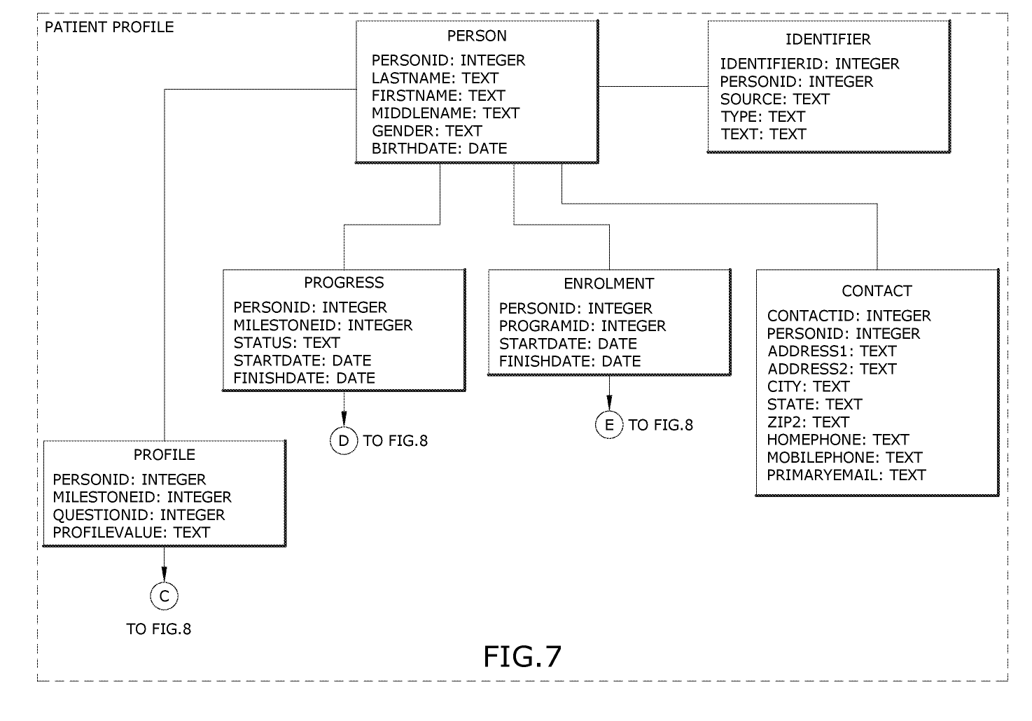

Referring the FIG. 6, there may be a plurality of major system components of the present invention: including a patient profile 30; a personalization engine 40; a health journey model 50; a content management service 60; a health systems integration 70; a data capture service 80; and a print service 90.

The patient profile 30 may be a set of data structures that represent what has been captured and analyzed regarding each user 24. It may include elements related to patient preferences (for system engagement and communication), initial and ongoing health status, health measurement data such as glucose levels and blood pressure readings, activity level, ongoing self-assessment data, and progress reporting.

The health journey model 50 may include structured data model outlines a typical pathway for a user 24 through a particular health condition such as diabetes or cardiac rehabilitation. A health journey may be composed of various phases (or stages) such as awareness, presence of symptoms, pre-diagnosis, diagnosis, treatment, follow-up care, and maintenance. A health journey may also indicate recommended “touch points” with the healthcare system or with healthcare providers. Also, other moments/events of interest may be identified as part of the health journey. A health journey may also identify the typical emotional characteristics and concerns that a patient might have during a particular phase of their journey.

The content model and content management components 60 may be an important element containing the relevant informational and education material that is presented to the user 24. The content model is organized in such a way that various discrete content elements can be used as part of the personalization service 40, such that the most appropriate content can be selected and presented based on an algorithm that references the patient profile 30 and health journey model 50 (see personalization service below).

The personalization service 40 references the patient profile 30, the health journey model, and the content model. It is used to compose the content of the program booklet, based on how the user 24 is progressing through their health journey, with additional criteria that is derived from the user 24 profile. The personalization service provides input into the print service to generate the user 24 personalized booklet/kit 10.

The data capture service 80 is one of the key elements of this hybrid patient-generated data system. A user 24 will complete one or more of the survey forms 14, tear off the form from the booklet 10, fold it, and mail it using the pre-addressed and postage-paid mailing envelope. The computing system may use automated image and character recognition to translate the hand-written paper forms into digital information (analog-to-digital conversion). As the booklets 10 and forms 14 contain encoded identity information, this identity will be used to associate the new data with an existing user 24 profile.

The print service 90 may be driven by the personalization service 40 and generates new and personalized program booklets for each user 24. The booklets may contain relevant content and data collection forms, based on the user 24 status within their health journey, as well as personal information from their profile. The print service 90 may provide document templates and the transmitting of the booklets to the user 24 on a regular basis, dependent on the program design.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A method of providing a personalize a health management program, comprising:
providing an initial booklet in a paper format to establish a baseline health profile for a predetermined health management program, wherein the paper format provides a separable survey having a plurality of questions related to health information pertinent to the predetermined health management program;
prompting a user to hand-write answer to the plurality of questions, wherein the hand-written answers comprise health data;
prompting the user to mail said initial survey to a predetermined address;
providing a computing system to receive and translate the hand-written answers into a digital patient profile comprising the health data, wherein the computing system is configured to associate the predetermined health management program with the digital patient profile for generating at least one personalized booklet based in part thereon; and
providing the at least one personalized booklet in said paper format to the user.

2. The method of claim 1, wherein the at least one personalized booklet further comprises personalized health content based in part on the digital patient profile.

3. The method of claim 1, wherein each separable survey includes a tear-off mailer mechanism.

4. The method of claim 3, wherein the tear-off mailer mechanism further comprises a tear line connecting the respective booklet and separable survey.

5. The method of claim 3, wherein each separable survey further comprises at least one fold line, peel-away paper and adhesive for mailing in the separable survey.

6. The method of claim 2, wherein the personalized health content includes goals associated with the predetermined health management program.

7. The method of claim 2, wherein the computing system further comprises:
a data capture service for translating the hand-written answers into the digital patient profile;
a personalization service coupled to the data capture for composing the personalized health content based on the digital patient profile; and
a print service coupled to the personalization service for generating at least one personalized booklet.
